(19) United States
(12) Patent Application Publication
(10) Pub. No.: US 2018/0201053 A1
(43) Pub. Date: Jul. 19, 2018

(54) CUSTOMIZED WEDDING RING AND PROCESS FOR CUSTOMIZING

(71) Applicant: MG GOLD DA AMAZÔNIA LTDA., Manaus (BR)

(72) Inventor: Roberto GRAZIANO, São Paulo (BR)

(73) Assignee: MG GOLD DA AMAZÔNIA LTDA., Manaus (BR)

(21) Appl. No.: 15/533,923

(22) PCT Filed: Aug. 24, 2016
(86) PCT No.: PCT/BR2016/000082

§ 371 Date: Jun. 7, 2017

(30) Foreign Application Priority Data
Aug. 25, 2015 (BR) 10 2015 020437- 0

(51) Int. Cl. B44C 1/22; A44C 9/00; A44C 27/00; B44B 7/00

(52) U.S. Cl. CPC B44C 1/228; B44B 7/007; A44C 27/00; A44C 9/00

(57) ABSTRACT

A customized wedding ring and process for customization, comprising a wedding ring, including sophisticated details made from noble materials, such as gold, silver, precious and semiprecious gems, also including combinations of every kind of noble or non-noble metals, as well as various gems, finishing or covers. In addition to these aspects, the wedding ring has its internal diameter customized with a personal etching of at least one stylized image, which may be a fingerprint, signature or caricature. The etched images are captured and previously treated by the appropriate digital equipment, and the treated images are inserted in a laser etching device which then etches the images onto the ring.

### FIELD OF THE INVENTION

The present invention relates to means for customizing a pair of or just a single wedding ring according to criteria set by the user. Customization is achieved by laser etching. The etching includes the preferences of each user and may be: (a) fingerprints from any of the fingers; (b) a signature or initials; and (c) caricatures or stylized photographs. In each case, images are electronically captured or scanned and individually treated, then subsequently inserted into a laser etching device to be etched over the internal diameter of one or more rings.

### BACKGROUND OF THE INVENTION

There are many resources known in the prior art to enrich a wedding ring with sophisticated details for personalization.

In the fashion world, it is essential to know the newest trends and to be able to use every style uniquely. To achieve even greater uniqueness, some fashion brands and designers have specialized in creating customized jewelry, designed for combination with a look with the correct style for the user. Obviously, jewelry will often have precious details. For rings, each ring is custom-made and personalized according to the preferences of each client. In many cases jewelry is manually produced for each client and, in some cases, even Reiki techniques are used to infuse the jewelry with positive energy, according to what the client is looking for (peace, love, curing energy, etc.). In some cases, the designer also makes use of personalization to allow the client to request specific pieces of jewelry for each different occasion, thus composing their look. It is also known that jewelers develop product lines enabling one to print various expressions and dates on their jewelry.

### SUMMARY OF THE INVENTION

The present invention refers to a customized wedding ring and means of customization. The invention links a personal print for each user to the internal diameter of the ring, thus adding one more item for its personalization and also offering a unique look, since the jewelry will now have a fully personalized component, designed for one single user, while also enriching its design, since personal details also work as an ornamental resource.

The ring of the present invention, regardless of the materials used, is designed and created using advanced manufacturing and finishing technologies, which are performed by computers, CNC machines and lasers, instead of using the traditional methods of casting and/or stamping, and the methods of production used for the present invention include strict quality control. This provides different technical and practical advantages not only concerning quality, but also concerning precision and stability. Although machine-made jewelry require more materials than jewelry made using traditional processes, the finished products are more precise and symmetric. Additionally, the laser etching process is able to provide better effects, and consequently the combination of advanced technology and personalized etching styles produces exceptional rings of better quality.

### BRIEF DESCRIPTION OF THE DRAWINGS

FIG. 1 shows an upper perspective view of a customized ring with the image of a laser-printed digital impression on the interior of the ring;

FIG. 2 shows another upper perspective view of a customized ring, however in this embodiment the ring has a laser-etched image of initials on the interior of the ring;

FIG. 3 shows one more upper perspective view of a customized ring with the image of a laser-printed caricature on the interior of the ring; and

FIG. 4 is a schematic view of an example of the printing process used to customize the rings of the present invention.

### DETAILED DESCRIPTION OF THE INVENTION

The invention will be described for the purposes of illustration only in connection with certain embodiments; however, it is to be understood that other objects and advantages of the present invention will be made apparent by the following description of the drawings according to the present invention. While a preferred embodiment is disclosed, this is not intended to be limiting. Rather, the general principles set forth herein are considered to be merely illustrative of the scope of the present invention and it is to be further understood that numerous changes may be made without straying from the scope of the present invention.

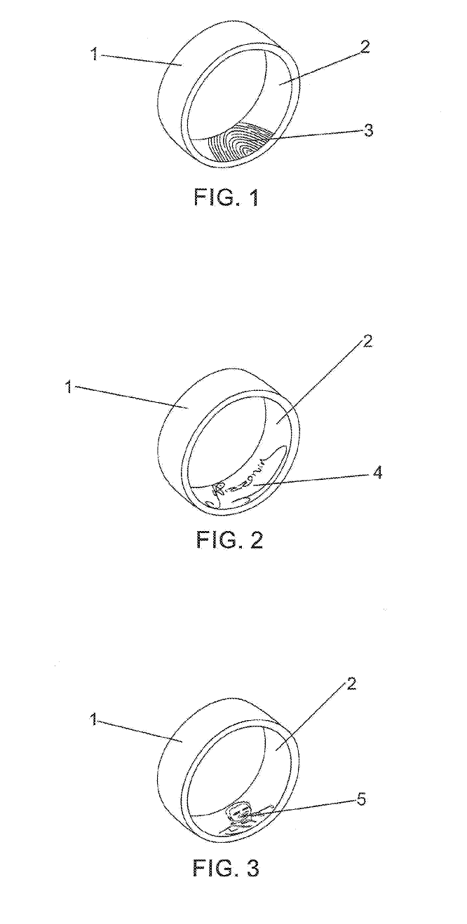

As can be seen in FIG. 1, the present invention comprises a wedding ring (1), including sophisticated details and made from precious materials, especially gold, silver, precious and semiprecious gems, and also including combinations of any kind of precious or nonprecious metals, as well as various gems, finishings or covers. Apart from these aspects, the wedding ring (1) is characterized by its internal diameter (2) being personalized with a personal etching of at least one stylized image.

As illustrated in FIG. 1, the main object of the present invention is to provide a means for etching an image onto the internal diameter (2) of the ring (1) and, in a first preferred embodiment, the etched image is a fingerprint (3) of the user themselves, consequently customizing the jewelry.

In FIG. 2, in another preferred embodiment of the present invention, the image to be etched on the internal diameter (2) of the ring (1) through desktop publishing resources, is a set of initials (4).

In another preferred embodiment, seen in detail in FIG. 3, the image to be etched on the internal diameter (2) of the ring (1) is a caricature (5).

A ring may contain more than one etched image, for example joining signatures, fingerprints and caricatures of a couple.

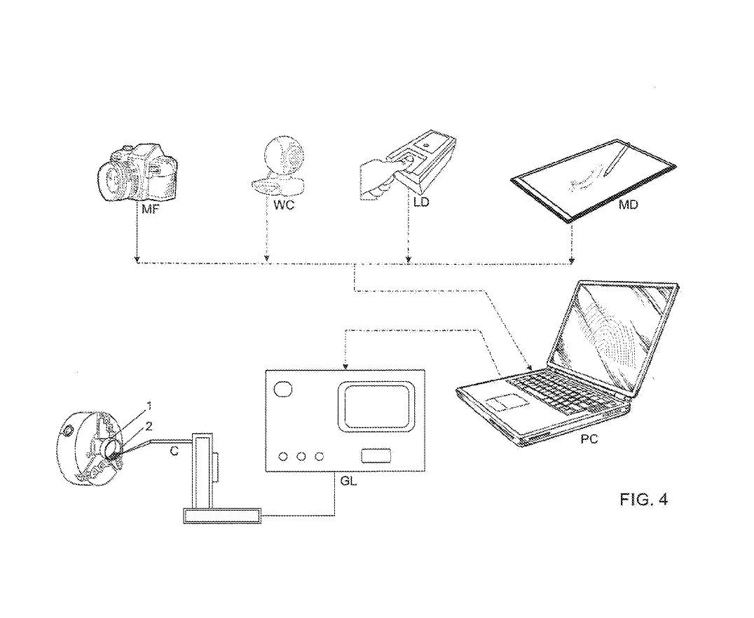

The etching process is schematically illustrated in FIG. 4, with the first step consisting of the digital scanning of the image to be printed, by using a photographic camera (MF), a webcam (WC), a digital reader (LD) or a digitalizing tablet (MD).

The captured image is then sent to a computer (PC) that has specific software installed;

The image as captured by the (PC), whether it be a fingerprint, caricature, signature, or other image, is then treated, adapting it for printing. All resources required for the electronic edition of images are used, especially involving color configuration, monochromatic details, sizing and other retouching, which will eventually need to be performed in order for the image to be made compatible with the etching system.

The treated image, ready for etching, is then sent to a laser etching device (GL); whereby the ring (1) is positioned on a mandrel (M) according to the slope as required for access to its internal diameter (2) by the laser cannon (C), as commanded by the etching device (GL).

All of the etching parameters are determined by the etching device (GL) which is computerized.

At the end of the image etching process, the ring (1) is removed from the mandrel (M) for further finishing. The etched ring then goes to quality control and receives any surface treatments as may be desired.

Different printed images may require different surface finishing, especially chemically, for example adding various materials, in color or monochromatically.

It will be understood that the specific characteristics and combinations of materials used in ring manufacture and the embodiment of the process of the present invention may vary considerably, while still maintaining the same concept of customization for the ring.

The disclosed embodiments are used as an example, and will clearly be subject to variation. However the scope of the inventive concept of the present invention remains the customization of a wedding ring by etching images onto its internal diameter, notably fingerprints.

1-6. (canceled)

7. A customized wedding ring comprising:
a ring having an internal diameter and made of a noble material, a non-noble material, or combinations thereof, and optional stones, finishing and covers,
wherein the internal diameter has a customized etching of at least one stylized image that is colored or monochromatic, and
wherein the customized etching is a copy, made by a laser etching device, of a captured digital image, and
wherein the captured digital image is input into a computerized system, the computerized system constructed and arranged to adapt the image to be compatible with a laser etching device and to drive the laser etching device.

8. The customized wedding ring of claim 7, wherein the customized etching is a fingerprint.

9. The customized wedding ring of claim 7, wherein the customized etching is initials.

10. The customized wedding ring of claim 7, wherein the customized etching is a caricature.

11. The customized wedding ring of claim 7, wherein the customized etching is a combination of signatures, fingerprints and caricatures.

12. A process for customization of a wedding ring as defined in claim 7, the process comprising the steps of:
a) digital capture and scanning of a customized image, wherein the capture and scanning of the image is performed using a device selected from the group consisting of: a photographic camera, a webcam, a digital reader, and a digitalizing tablet;
b) sending the captured image to a computer with a computerized system;
c) treatment of the captured customized image by the computerized system to adapt the image to be compatible with a laser etching device; using electronic editing of images resources;
d) sending the treated captured image to the laser etching device;
e) placing the ring on a mandrel of the laser etching device, wherein the ring is positioned on a slope to allow access to the internal diameter of the ring by a laser cannon of the laser etching device, wherein the positioning of the ring is commanded by the laser etching device, and the laser etching device determines all etching parameters, and
a) following etching of the image, the ring is removed from the mandrel for a finishing and a surface treatment.
